(19) United States
(12) Patent Application Publication
(10) Pub. No.: US 2026/0102235 A1
(43) Pub. Date: Apr. 16, 2026

(54) Catch

(71) Applicant: Heather Koetteritz, Crown Point, IN (US)

(72) Inventor: Heather Koetteritz, Crown Point, IN (US)

(21) Appl. No.: 19/360,382

(22) Filed: Oct. 16, 2025

Related U.S. Application Data
(60) Provisional application No. 63/708,103, filed on Oct. 16, 2024.

(51) Int. Cl. A61C 17/14; A61C 17/22

(52) U.S. Cl. CPC A61C 17/14; A61C 17/22

(57) ABSTRACT

A residue-catching device for orally inserted appliances includes a flexible body having a cavity positioned adjacent a working end of the appliance to intercept residue before it reaches the handle. The device may be installed between a detachable head and handle or slipped over the head. Preferred materials include food-grade silicone. The device is adaptable to toothbrushes, flossers, irrigators, and dental tools.

### CROSS-REFERENCE TO RELATED APPLICATIONS

The present application claims the benefits of U.S. Provisional Ser. No. 63/708,103, filed Oct. 16, 2024, the entirety of which is hereby incorporated by reference.

### BACKGROUND OF THE INVENTION

The inventor noted that when people use an orally inserted device, such as an electric toothbrush to name one example, a liquid residue occurs. Users like the functionality and use of such a device, the toothbrush for instance, but do not like the residues left on the device.

Residue, often caused by a mixture of saliva and soap, collect on a handle and a charging base of an orally inserted device, such as a toothbrush. Too, the residue collects with each use on a user's hand.

There is a need in the industry for an apparatus that allows users to catch the residue before it reaches other surfaces, handles, chargers, hand, etc. I noticed that by positioning a catch near a head of the device, such as an electric toothbrush for instance, this was a way to capture the residues. An apparatus and method for using it are not currently available in the industry.

### SUMMARY

The present invention is directed to an apparatus that satisfies this need. I envisioned a device capturing any residues before reaching another surface, such as a handle to name one example of such a surface.

The present invention further relates to a residue-catching device for orally inserted appliances, such as electric toothbrushes. The invention comprises a funnel-shaped catch designed to intercept and collect residue-such as saliva, toothpaste, or soap-before it can reach the handle, charging base, or the user's hand. The catch is positioned between the head and the handle of the device, using a seat portion that fits within the gap between the detachable head and body. The apparatus is made of pliable materials, such as silicone, allowing for easy attachment, detachment, and cleaning. The device is adaptable to a variety of electric toothbrush models and may also be used with other orally inserted devices, thereby enhancing hygiene and reducing maintenance.

Even further, the present invention provides a residue-catching device configured for use with an orally inserted appliance. In one embodiment, the device comprises a main portion having a cavity or funnel-like shape, a seat portion configured to fit between two separable portions of the appliance (e.g., between the head and handle of an electric toothbrush), and an opening through which the appliance extends. The cavity intercepts residue migration, stopping residue before it travels toward the handle or user's hand.

The device is preferably formed of pliable, washable material, such as food-grade silicone, allowing for easy installation, detachment, and cleaning (including dishwashing). The design is adaptable to different models of electric toothbrushes and other appliances, and alternative embodiments allow for installation without separating appliance components—such as a slip-over configuration.

In another embodiment, the device is provided in combination with an orally inserted appliance, forming an assembly in which the catch is integrated at the junction between the working end and the handle.

In a more general aspect, the device comprises a main portion that defines a cavity sized and shaped to collect residue. The cavity is oriented adjacent a working end of the appliance such that drips of saliva, toothpaste, or other material fall into the cavity rather than migrating downward.

The main portion further includes a seat portion, which functions to position and secure the device in place relative to the appliance. In some embodiments, the seat portion is dimensioned to fit between a detachable head and handle of the appliance, such as in an electric toothbrush where the brush head is separable from the powered handle. This arrangement provides a stable and repeatable placement for the device.

The main portion also defines an opening through which at least part of the appliance extends. This allows the device to be mounted around the appliance shaft while leaving the working end exposed for use. By surrounding the appliance at this junction, the cavity is positioned to intercept residue before it can reach the handle or the user's hand.

In certain embodiments, the main portion is funnel-shaped, thereby directing liquids or debris into the cavity efficiently. In other embodiments, the main portion is formed of a pliable material, such as food-grade silicone, which permits stretching over the appliance, easy attachment and detachment, and convenient cleaning. The pliability also allows the device to be manufactured with an adjustable portion, such as a flexible wall or stretchable ring, configured to fit multiple appliance diameters without requiring custom sizing.

The invention is not limited to a single type of appliance. While one embodiment is an electric toothbrush, the device is also suitable for use with other orally inserted appliances, including manual toothbrushes, powered flossers, oral irrigators, whitening devices, and intraoral medical or dental instruments.

In another aspect, the invention provides a combination of an orally inserted appliance having a working end and a handle, together with the residue-catching device installed between the working end and the handle. In some implementations, the residue-catching device is integrally formed with the appliance, such as by molding or manufacturing the device as a unitary part of the appliance assembly.

In yet another aspect, the invention provides a method of reducing residue migration. The method includes detaching a first portion of an appliance from a second portion, positioning the residue-catching device between the portions, and then reattaching the portions with the device secured in place. In certain embodiments, the method further includes cleaning the device by placing it in a dishwasher. The method is applicable to a wide variety of appliances, including but not limited to electric toothbrushes, manual toothbrushes, powered flossers, oral irrigators, whitening devices, and intraoral medical or dental instruments.

Through these aspects, the invention improves hygiene by preventing residue accumulation on handles and charging bases, reduces cleaning requirements, and provides a convenient, adaptable solution that can be reused across different appliances.

### BRIEF DESCRIPTION OF THE SEVERAL VIEWS OF THE DRAWINGS

These and other features, aspects and advantages of the present invention will become better understood with regard to the following description, appended claims, and accompanying drawings where:

FIG. 1 is a perspective view of one embodiment of the invention installed between the head and handle of an electric toothbrush.

FIG. 2 is a perspective view of another embodiment in use by a professional, showing an alternative shape and opening configuration.

FIG. 3 is a further perspective view of the embodiment of FIG. 2, illustrating the same structural relationship of the opening 22.

### DESCRIPTION

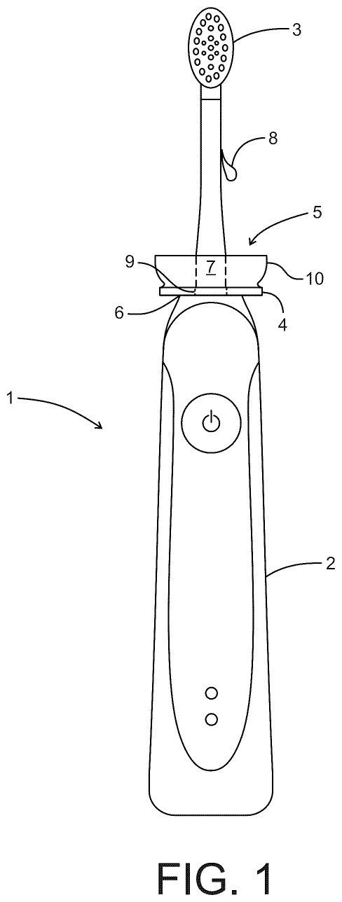

As shown in FIG. 1, a perspective view of an embodiment of the present invention comprises a main portion 7 for use with an apparatus that is an orally inserted device 1, such as an electric toothbrush. The orally inserted device 1 having a first end 3 and a second end 2. The main portion 7 having a cavity 5, like that of a funnel. The main portion 1 having a seat portion 4. And a capturing portion 10.

The main portion 7 has a hole 9 through which the second end 2 can partially fit. The seat portion 4 fitting in a gap 6 between the first end 3 and the second end 2 when the two ends are attached. When the orally inserted device 1 experiences residue dripping 8, the residue drip is captured in the cavity 5 and dodges other surfaces.

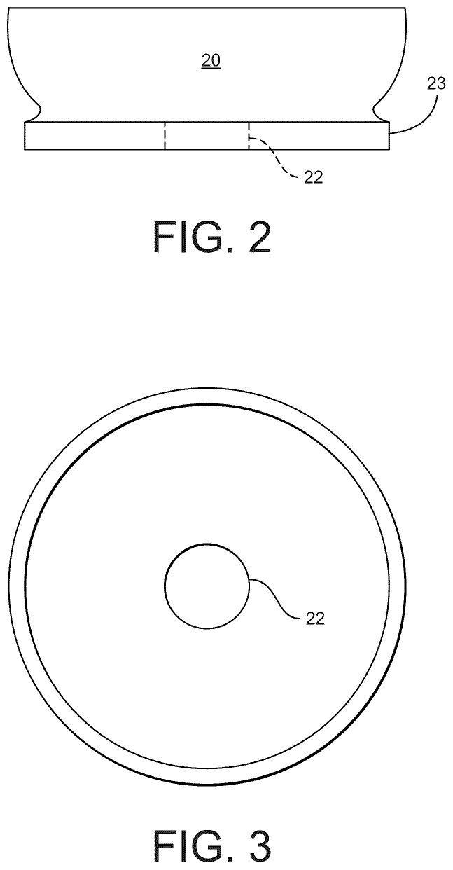

As shown in FIG. 2, a perspective view of another embodiment of the present invention comprises an apparatus with a main portion 20. There is a hole 22 passing through the wall of the main portion 20. The hole, 22, because it can be made from a pliable material makes an adjustable portion that can fit over varying diameters, it can be stretched over different types of appliances. The apparatus has a seat portion 23.

I found that this design and method of dodging residue buildup on surfaces by putting a funnel like catch between the head of an electric toothbrush and the main body of the toothbrush is a versatile design. Too, it can be used to capture residue that drips down from other orally inserted devices not just electric toothbrushes.

My improved method involves detaching a first part from a second part, fitting the inventive apparatus into a space between the first and second parts, then reattaching the first and second parts with the inventive apparatus secured between the parts.

Broadly, one embodiment of the residue-catching apparatus for an orally inserted appliance comprises a flexible body configured to be mounted adjacent a working end of the appliance. Also, the body defining a surface or cavity positioned to intercept residue migrating from the working end toward a handle. Wherein the body is removably attachable to the appliance without impairing operation of the appliance.

More generally and again referring to FIG. 1, an orally inserted appliance 1, such as an electric toothbrush, includes a first end 3 (working end or head) and a second end 2 (handle). Between these, the inventive catch 7 is installed. The catch 7 defines a cavity 5 shaped to collect residue. A seat portion 4 fits into a gap 6 between the first end 3 and the second end 2 when those portions are attached. The catch includes an opening 9 through which the second end 2 partially extends. The seat portion 4, in its best model, having an outer diameter of approximately 1 inch and wall thickness of about 2 mm.

When in use, residue drips 8 travel downward from the working end. The cavity 5 intercepts and contains the residue, preventing migration to the handle, charger, or user's hand. The residue will evaporate over time.

For an alternative embedment, referring again to FIG. 2, a main portion 20 defines a through-hole 22 and a seat portion 23. This embodiment may be dimensioned for use with a variety of oral appliances, including manual toothbrushes, powered flossers, whitening devices, or intraoral medical instruments.

In some embodiments, the catch is installed by detaching the appliance's head from the handle, placing the seat portion into the junction, and reattaching the head. In other embodiments, the catch is slipped over the head without detachment, using a flexible opening or slit.

Preferred materials include food-grade silicone, thermoplastic elastomers, or other pliable polymers. These materials permit easy cleaning, including dishwasher cleaning.

The device may be manufactured in different sizes, shapes, or colors to fit multiple appliance designs, and may include adjustable or stretchable sections to accommodate different diameters.

In a combination embodiment, the catch is pre-installed or integrally formed with an oral appliance. This arrangement can be sold as a single hygienic assembly, increasing user convenience and compliance.

The device could have variations such as comprising a drainage channel or textured inner surface for directing residue away from the handle; being dishwasher-safe or sterilizable at temperatures up to 225 F; or comprising a slit or stretchable opening allowing installation without disassembly of the appliance.

Although the present invention has been described in considerable detail with reference to certain preferred versions thereof, other versions are possible. For instance, the apparatus might include a main portion that merely fits over a toothbrush and is not inserted between the head and body. Therefore, the spirit and scope of the appended claims should not be limited to the description of the preferred versions contained herein.

Insofar as the description above and the accompanying drawings disclose any additional subject matter that is not within the scope of the claims below, the inventions are not dedicated to the public and the right to file one or more applications to claim such additional inventions is reserved by me.

What I claim is:

1. A residue-catching device for an orally inserted appliance, comprising:
a main portion defining a cavity for collecting residue;
a seat portion configured to position the main portion adjacent a working end of the appliance;
an opening through the main portion configured to receive a portion of the appliance;
the cavity being positioned to intercept residue before the residue reaches a handle of the appliance.

2. The device of claim 1 wherein the seat portion is configured to fit between a detachable head and handle of the appliance.

3. The device of claim 1 wherein the main portion is funnel-shaped.

4. The device of claim 1 wherein the main portion is formed of a pliable material.

5. The device of claim 4 wherein the pliable material is food-grade silicone.

6. The device of claim 1 further comprising an adjustable portion configured to fit multiple appliance diameters.

7. The device of claim 1 wherein the appliance is an electric toothbrush.

8. The device of claim 1 wherein the appliance is selected from the group consisting of:
manual toothbrushes, electric toothbrushes, powered flossers, oral irrigators, whitening devices, and intraoral dental instruments.

9. The device of claim 1 further comprising a drainage channel or textured inner surface for directing residue away from the handle.

10. The device of claim 1 being dishwasher-safe or sterilizable at temperatures up to 225 F.

11. The device of claim 1 further comprising a slit or stretchable opening allowing installation without disassembly of the appliance.

12. A combination comprising:
an orally inserted appliance having a working end and a handle;
a residue-catching device according to claim 1 installed between the working end and the handle.

13. The combination of claim 12, wherein the residue-catching device is integrally formed with the appliance.

14. A method of reducing residue migration in an orally inserted appliance, comprising:
detaching a first portion of the appliance from a second portion;
positioning a residue-catching device according to claim 1 between the first and second portions;
reattaching the first portion to the second portion, thereby securing the device in place.

15. The method of claim 14, further comprising cleaning the residue-catching device by placing it in a dishwasher.

16. The method of claim 14, wherein the appliance is an electric toothbrush.

17. The method of claim 14, wherein the appliance is selected from the group consisting of:
manual toothbrushes, powered flossers, oral irrigators, whitening devices, and intraoral medical or dental instruments.

18. A residue-catching apparatus for an electric toothbrush comprising:
a flexible body configured to be mounted adjacent a working end of the toothbrush;
the flexible body defining a surface or cavity positioned to intercept residue migrating from the working end toward a handle of the toothbrush;
wherein the flexible body is removably attachable to the toothbrush without impairing operation of the toothbrush.
